(19) United States
(12) Patent Application Publication
(10) Pub. No.: US 2026/0229202 A1
(43) Pub. Date: Aug. 6, 2026

(54) ARRANGEMENT, KEY AND METHOD FOR PRODUCING AN ARRANGEMENT AND A KEY

(71) Applicant: Piano-Schulz e.K., Wiesbaden (DE)

(72) Inventor: Christoph Schulz, Wiesbaden (DE)

(73) Assignee: Piano-Schulz e.K., Wiesbaden (DE)

(21) Appl. No.: 19/151,340

(22) PCT Filed: Jan. 26, 2024
(86) PCT No.: PCT/EP2024/051899

§ 371 Date: Sep. 9, 2025

(30) Foreign Application Priority Data
Jan. 26, 2023 (DE) 102023200631.6

(51) Int. Cl. G10C 3/12; G10C 9/00

(52) U.S. Cl. CPC G10C 3/12; G10C 9/00

(57) ABSTRACT

An arrangement comprising a key, and a method for producing a key, wherein a key body of the key comprises a first balance rail pin recess for receiving a first balance rail pin, wherein the key body comprises at least one further balance rail pin recess for receiving a further balance rail pin and/or at least one fastening element for fastening at least one replaceable guide insertion element in at least one recess in the key body.

### BACKGROUND OF THE INVENTION

### 1. Field of the Invention

The invention relates to a key, to an arrangement comprising a key, and to a method for producing an arrangement and a key.

### 2. Brief Description of the Related Art

During production and in maintenance processes, keys of keyboard instruments are inserted into the keyboard instrument from outside and are movably mounted on a main body of the instrument or elements thereof. After being inserted, it may be necessary to adjust a position and/or orientation of the key. In particular, it may be necessary to “level” the key, for example in order to ensure that all the keys are arranged at the same height and in parallel with one another when they are unactuated. Likewise, during production and maintenance, it may be necessary to fasten wear parts, such as felt elements for key guidance, to the key or to replace them.

DE 103 126 55 A1 discloses upright keyboard instruments which give a realistic key feel when keys are pressed down and released. U.S. Pat. No. 1,813,751 A discloses a musical instrument key comprising guide means and a compressible sleeve. US 2014/299458 A1 discloses a piano keyboard and 3D printing methods for producing elements of this keyboard.

### SUMMARY OF THE INVENTION

It poses the technical problem of providing a key of a keyboard instrument, an arrangement comprising a key of this kind, and a method for producing a key of this kind which simplify production and maintenance of the key.

The solution to the technical problem results from the subjects having the features of the independent claims. Further advantageous configurations of the invention are found in the dependent claims.

A key of a keyboard instrument is proposed. This can be a key of a keyboard of a piano, a grand piano, a keyboard, a digital piano, or an organ or another keyboard instrument. The key comprises a key body. A material of the key body can be wood. However, the material of the key body can also be a plastics material, in particular if the key has been produced by means of an additive manufacturing method, e.g. a 3D printing method. The key body can be an elongate component. A front end of the key body denotes the end of the key body which is closest to the player when the key is installed in the instrument for its intended use. A longitudinal axis of extension of the key body can extend from the front end to the rear end of the key, the rear end denoting the end of the key remote from the player in the installed state as mentioned. The longitudinal axis of extension can in particular extend through a geometric midpoint of the cross-sectional area of the key body, the cross-sectional area being able to be arranged in a cross-sectional plane perpendicular to the longitudinal axis of extension. The longitudinal axis of extension can extend in a straight line. If the key body is angled or curved, the longitudinal axis of extension can also extend along a curved or bent line.

A longitudinal direction of extension can be oriented from the front end to the rear end of the key. At each point on the longitudinal axis of extension, a Cartesian coordinate system can be defined which comprises the longitudinal axis of extension, a vertical axis, and a transverse axis. The (in particular straight) vertical axis can be oriented from the lower face to the upper face and perpendicularly to a (non-curved) portion of the upper face and/or lower face, a vertical direction being able to be oriented from the bottom to the top. An (in particular straight) transverse axis can be oriented perpendicularly to the two mentioned axes.

Furthermore, the key body comprises an upper face and a lower face. To use it as intended, the player actuates the upper face of the key body in the region of the front end or a covering applied thereto. A portion of the lower face of the carrier body can be designed to rest on a balance rail of the instrument or balance element that is different therefrom, e.g. on a support portion of a balance rail pin. The entire surface or at least a portion of the surface of the upper face and/or the lower face can be designed to be non-curved. It is possible for the key body to comprise or form a weight portion on the lower face. This portion can be designed as a raised region on the lower face, for example. The raised region can in particular have a convex shape. It is also possible for the key body to comprise a key button on the upper face, which is designed as a raised region on the upper face.

The key body of the key comprises a first balance rail pin recess for receiving a first balance rail pin. According to a first alternative according to the invention, the key body comprises at least one further balance rail pin recess for receiving a further balance rail pin.

These balance rail pin recesses can each be arranged or formed on the lower face. The balance rail pin recesses can be formed in the manner of a blind hole, but preferably as through-openings, the through-openings extending from the lower face to the upper face. If the key body comprises a key button, the first and/or the further balance rail pin recess can extend through the key button. The first balance rail pin recess can comprise at least one portion tapering from the upper face of the key body toward the lower face. Here, the first balance rail pin recess can form a key base. For example, it is conceivable for the first balance rail pin recess to be cylindrical in portions or in its entirety. This recess can also comprise at least two cylindrical portions. Different cylindrical portions can have different diameters, the diameters increasing from a lower face of the key body toward an upper face of the key body.

The first balance rail pin recess in particular serves to receive the first balance rail pin in a form-fitting manner. The first balance rail pin prevents or reduces translational movability of the key body relative to the pin (and thus to a balance rail to which the pin is fastened) when this pin is arranged in the first balance rail pin recess. For instance, translational movability is prevented or reduced in a direction oriented in parallel with the longitudinal axis of extension of the key (i.e. in or counter to the longitudinal direction of extension), in particular along the longitudinal axis of extension in the region of the first balance rail pin recess. Translational movability is also prevented or reduced in parallel with the transverse direction, in particular the transverse direction in the region of the first balance rail pin recess. The further balance rail pin prevents or reduces rotational movability, in particular the key tilting about an axis oriented parallel to the longitudinal axis of extension. It is possible for the further balance rail pin to be bent in order to align the key in the installed state, i.e. to arrange it in a predetermined spatial position relative to other keys, e.g. as part of leveling them.

The first and the further balance rail pin recess are arranged in a central portion of the key body. The central portion is arranged between a front portion and a rear portion of the key body. A length of the central region can adopt a value from an interval of 20% to 80% of the total length of the key. A midpoint of the central region in the longitudinal direction of extension can in particular correspond to the midpoint of the key in the longitudinal direction of extension. The position of the first balance rail pin recess defines a lever ratio provided by the key in the installed state and thus also a fulcrum of the key body when used as intended during playing. In a grand piano, this fulcrum can be arranged centrally along the total length or in a range of 0.45 to 0.55 of the total length in the longitudinal direction of extension. In a piano, this fulcrum can be arranged in a range of 0.55 to 0.60 of the total length in the longitudinal direction of extension. Geometric centers of the two recesses, in particular the geometric midpoints of the openings on the lower face, can be arranged on a straight line oriented in parallel with the longitudinal direction of extension. Furthermore, recesses can be arranged in a contact region for contacting the balance rail. The further balance rail pin recess can be arranged behind the first balance rail pin recess in the longitudinal direction of extension.

The first and the further balance rail pin recess can be designed to have geometric shapes that differ from one another.

Providing a key comprising two balance rail pin recesses advantageously simplifies the production and maintenance of the keyboard instrument since, in particular, the alignment of the key is simplified. This may be necessary in particular for leveling the key. For instance, by there being two balance rail pin recesses, one of the pins, namely the first balance rail pin, provides the described functionality (first functionality) of limiting the translational movability, while the remaining pin, namely the further balance rail pin, provides the limitation of the translational movability (further functionality). By splitting up these functionalities, a pin can be handled/adjusted without impairing the functionality of the remaining pin. Since the provision of the first functionality can be ensured at a shorter length of the pin in comparison with the further functionality, it may also be possible to remove the key in a simplified manner since the key has to be moved upward to a lesser extent in order to be removed. This is explained in greater detail in the following.

According to another alternative according to the invention, as an alternative to or in addition to the features of the first alternative according to the invention, the key body comprises at least one fastening element for fastening at least one replaceable guide insertion element in at least one recess in the key body. The at least one fastening element can also be formed by the key body. The recess can be one of the two balance rail pin recesses explained above. The recess can also be a front pin recess for receiving a front pin. Therefore, at least one guide insertion element can be arranged in exactly one, exactly two, or in all three of the following recesses: the first balance rail pin recess, the further balance rail pin recess, and the front pin recess. If the key body comprises a key button, the guide insertion element can also be fastened in the key button.

It is also possible for the key body to comprise or form exactly one or more fastening elements for fastening a plurality of, in particular two, replaceable guide insertion elements in a recess, e.g. for fastening to opposite side walls of the recess, e.g. lateral or longitudinal side walls.

The front pin recess can be arranged in a front portion, i.e. a portion of the front end, of the key. Here, the fastening element is designed for detachably fastening the insertion element to the key body. Therefore, the insertion element can be replaced without damaging the key body. The guide insertion element can e.g. be a felt insertion element, a guide element of this insertion element being designed as a felt element. Alternatively, the guide element of the insertion element can be made of a different material that has predetermined sliding and/or damping properties for movement guidance of the key body. The guide element can also be designed as a portion of the guide insertion element, which is explained in greater detail in the following. The fastening element can allow for form-fitting and/or force-fitting fastening of the insertion element, in particular a clamping or latching connection. This advantageously results in simplified production and maintenance of the key, in particular simplified insertion of a guide element for movement guidance of the key or simplified replacement of a worn guide element.

In another embodiment, the further balance rail pin recess comprises at least one portion tapering from the lower face of the key body toward the upper face. It is possible for the further balance rail pin recess to comprise a further, non-tapering portion in addition to the tapering portion in order to receive the further balance rail pin, which adjoins the tapering portion in the direction of the upper face. In other words, the further balance rail pin recess can therefore comprise a portion which widens from the upper face toward the lower face, in particular in the longitudinal direction of extension. The further balance rail pin recess preferably widens toward the rear end of the key. The widening portion advantageously results in simplified removal of the key, which is explained in greater detail in the following.

In another embodiment, a distance between the first and the further recess is less than 2 cm. In this case, the distance can e.g. be measured between geometric centers of the opening of the recesses on the lower face. This advantageously results in simplified removal of the key, and simultaneously reliable alignment of the key body is made possible.

In another embodiment, a guide element, e.g. a felt element, is arranged in at least one portion of the first and/or the further recess and/or a front pin recess in the key body. The guide element is used to guide the key body along the balance rail pin when it is arranged in the corresponding recess. The guide element can be arranged at an upper end of the recess. If the key body comprises a key button, the guide element can be arranged in the key button. The guide element can also only be arranged in a portion of the side wall that surrounds the recess. For example, the guide element can be arranged on one or both lateral side walls of the recess or a portion of these lateral side walls. In this case, lateral side walls denote the side walls in the above-mentioned transverse direction in the portion of the key body in which the recess is arranged. Alternatively or additionally, a guide element can be arranged on a longitudinal side surface or a portion thereof which delimits the recess in relation to the longitudinal direction of extension. Here, the guide element can be part of the above-mentioned guide insertion element and can thus be arranged in the first and/or the further recess in a replaceable manner. In this case, the size of at least one portion of the recess can be selected such that at least one guide insertion element and the corresponding balance rail pin can be arranged therein. However, it is also conceivable for the guide element not to be part of a guide insertion element. In this case, the size of at least one portion of the recess can be selected such that at least one guide element and the corresponding balance rail pin can be arranged therein. Arranging a guide element advantageously results in low-wear, quiet, and reliable movement guidance of the key body.

In another embodiment, the further recess is rectangular in a cross-sectional plane oriented in parallel with an upper face of the key body, in particular thus perpendicularly to the vertical direction. This advantageously results in simple manufacturing of the further recess, which allows the key body to be installed and removed in a simple manner.

In another embodiment, the fastening element is designed for fastening a replaceable guide insertion element as an undercut portion of the recess. This undercut portion is used to receive a portion of the guide insertion element which then cannot be removed from the recess in at least one spatial direction, for example in the above-mentioned transverse direction and/or in the above-mentioned longitudinal direction of extension when it is in the received state. Preferably, the undercut portion is arranged and/or designed such that it is possible to insert the guide insertion element into the recess from below and also remove it downward, with it not being possible to insert and remove it in other spatial directions, i.e. from above, from the front, from the rear, or from the sides. This is just one possible embodiment, however. For instance, alternatively or additionally the undercut portion can also be arranged and/or designed such that it is possible to insert and remove the guide insertion element in at least one other spatial direction, in particular from above/upward. Preferably, the undercut portion makes it possible to insert and remove the guide insertion element downward in the case of a front pin recess and to insert and remove the guide insertion element upward in the case of a balance rail pin recess.

The undercut portion can be arranged and/or designed such that the guide insertion element can be received in a form-fitting and/or force-fitting manner. This advantageously results in simple production of a key body, which allows a guide element to be arranged in the recess in a replaceable manner. This can again simplify production of the key body as well as repair/maintenance, since the insertion process and the replacement process can be significantly simplified.

In a preferred embodiment, the undercut portion does not extend over the entire depth of the recess. For example, the undercut portion can extend from the lower face of the key body toward the upper face, but not over the entire depth of the recess, meaning that a stop surface is advantageously provided for a guide insertion element inserted from below. The undercut portion can also extend from the upper face of the key body toward the lower face, but not over the entire depth of the recess, meaning that a stop surface is advantageously provided for a guide insertion element inserted from above.

This advantageously makes it possible to reliably fasten the guide insertion element in the recess and simplifies correct insertion. However, it is of course also possible for the undercut portion to extend over the entire depth of the recess.

An arrangement comprising a first balance rail pin and at least one key is also proposed in accordance with one of the embodiments described in this disclosure. The first balance rail pin can be fastened to a balance rail or a portion of a main body of the keyboard instrument, in particular can project therefrom.

According to the invention, the arrangement comprises at least one further balance rail pin, which is arranged in the further balance rail pin recess. The further balance rail pin can likewise be fastened to the balance rail or the portion and in particular can protrude therefrom. As already explained above, this advantageously results in reliable movement guidance of the key movement in the installed state of the key, removal for maintenance/repair purposes also being simplified.

Alternatively or additionally, the arrangement comprises at least one replaceable guide insertion element, the at least one guide insertion element being arranged in at least one recess in the key. The arrangement can also comprise at least one front pin, the front pin being arranged in the front pin recess in the key. Here, the front pin can be fastened to a portion of the main body of the instrument, in particular can protrude therefrom.

If both a pin and a guide insertion element are arranged in a recess, the arrangement can be such that direct mechanical contact between the pin and the key body is prevented and there is only mechanical contact between the pin and the guide element or portion of the guide insertion element, in particular in the above-mentioned longitudinal direction of extension and/or transverse direction. This advantageously results in an arrangement which ensures reliable movement guidance of the key, while at the same time simple production and maintenance/repair is made possible owing to the replaceable arrangement of the guide insertion element.

In another embodiment, the further balance rail pin is longer than the first balance rail pin. For example, the length of the first balance rail pin is less than or equal to 10 mm, while the length of the further balance rail pin can be less than or equal to 35 mm. The further balance rail pin can be arranged in the longitudinal direction of extension behind the first balance rail pin. Designing the further balance rail pin to be longer advantageously means that it can reliably prevent the key body from tilting, while the first balance rail pin can reliably prevent the key body from slipping/wobbling in and counter to the longitudinal direction of extension. Furthermore, this advantageously means that, when it is removed, the key body has to be raised to a lesser extent in order to move the first balance rail pin out of the corresponding recess, which also means that the key body can be removed counter to the longitudinal direction of extension by the key body being raised to a lesser extent. This allows for simple removal that is gentle on the material. If, specifically, the key body has to be raised or tilted to a great extent in order to move the first balance rail pin out of the corresponding recess, in an upright piano the lower face of the key can be mechanically stressed in the region of the rear end, since the key body is tensioned when it is raised between the stop mechanism arranged above the key body and the main body of the piano arranged below the key body. The key base can also be stressed, which can wear out owing to this stress. Because the key body only needs to be raised to a low extent to be removed, the invention advantageously makes it possible to reduce or prevent these stresses. In a grand piano, the invention advantageously makes it possible to remove a key body or to move the first balance rail pin out of the corresponding recess, which e.g. is required for inserting a paper disk, without removing the stop mechanism.

In another embodiment, the first balance rail pin comprises a support portion for supporting the key body. The support portion can be formed by a portion protruding from the pin body, for example. A portion of this kind can e.g. be a disk-shaped portion. It can protrude from a cylindrical pin body. Here, the support portion can be arranged in a longitudinal direction of extension of the balance rail pin in a central region of the balance rail pin. In such a case, an upper portion of the balance rail pin can project into the receiving portion in the key body, the lower face, in particular a weight portion, of the key body resting on an upper surface of the support portion, in particular permanently. A remaining lower portion of the balance rail pin can be fastened to/in the balance rail. This advantageously results in simple height adjustment of the key, since the key height can also be set by the height of the support portion above the balance rail. It is conceivable for the height of the support portion above the balance rail to be able to be changed, for example by moving the balance rail pin. If the balance rail pin is screwed into the balance rail, the balance rail pin can be screwed into/out of the balance rail to adjust the height. It is also conceivable for the support portion itself to be movably arranged on the balance rail pin or the pin body.

Alternatively or additionally, the first balance rail pin comprises a threaded portion. It can in particular be provided/arranged on a lower end of the balance rail pin. It can be provided for screwing the balance rail pin into a thread in the balance rail or into a material of the balance rail. This advantageously results in a height of a support portion rigidly arranged on the balance rail pin above the balance rail being able to be set, namely by the balance rail pin being rotated, meaning that the balance rail pin rotates into the balance rail or out of the balance rail owing to the threaded portion.

It is conceivable for a spacer element, for example a felt or paper element, to be arranged on the support portion, a key body then resting on the spacer element. By selecting a thickness of the at least one spacer element, the height between the lower face of the key body and the balance rail, and thus a key height, can likewise be set here.

Overall, the support portion and/or the threaded portion result in simple alignment of the key body, in particular in setting the key height in a simple manner in the installed state.

In another embodiment, the first balance rail pin comprises an actuation portion for tool-assisted actuation. The actuation portion can in particular be arranged and/or formed on an upper end of the balance rail pin. For example, the actuation portion can be designed as a receiving portion for receiving a tool, such as a hex tool or socket tool. Therefore, it can in particular be possible to actuate the first balance rail pin through an opening in the receiving portion on the upper face of the key body using a tool, for example in order to rotate the balance rail pin. As a result, it can be screwed into the balance rail or out of the balance rail, for example as explained, and this makes it possible to set a length of the part of the balance rail pin arranged in the receiving portion, for example. If a support portion is arranged on the balance rail pin, a height can also be set by the actuation, as likewise explained. This therefore advantageously allows the key body to be mounted in a simple manner, in particular also to be adjusted in a simple manner, namely by tool-assisted actuation of the first balance rail pin.

In another embodiment, the guide insertion element comprises a guide element, e.g. a felt element, and a carrier element. The carrier element can in particular be designed to be planar, i.e. in the form of a carrier plate. In this case, the guide element can be fastened to the carrier plate, for example so as to be detachable, but also non-detachable. In particular, the guide element can be bonded to the carrier element. The carrier element can be designed as an injection-molded element. A material of the carrier element can be plastics material. However, other materials can also be used to produce the carrier element. It is also possible for the guide element and the carrier element of the guide insertion element to be designed to be monolithic, i.e. in the form of an inseparable unit. In particular, in this case, the carrier element, the guide element, or the entire guide insertion element can be produced using an additive manufacturing method. In this case, the guide element can be provided in the form of a portion of the guide insertion element having a predetermined sliding and/or damping property. This advantageously results in simple production of the replaceable guide insertion element.

A method for producing an arrangement comprising a first balance rail pin, at least one further balance rail pin, and at least one key is also proposed. The arrangement can in particular be designed in accordance with one of the embodiments described in this disclosure. Therefore, the method can also comprise further steps for producing an arrangement of this kind.

In this case,
a key body of the key comprising a first balance rail pin recess for receiving the first balance rail pin and comprising at least one further balance rail pin recess for receiving a further balance rail pin is provided,
the first balance rail pin is arranged in the first balance rail pin recess, and
the further balance rail pin is arranged in the further balance rail pin recess.

The first balance rail pin also comprises a support portion for supporting the key body, a lower face of the key body being arranged to rest on an upper surface of the support portion. The first balance rail pin also comprises a threaded portion for screwing into a thread or material of the balance rail. A balance rail or a portion of a main body of the keyboard instrument can also be provided as part of the arrangement, the threaded portion of the first balance rail pin being screwed into the balance rail or the portion.

In this case, the key can be produced as described in greater detail in the following. Overall, a method for producing an arrangement having the above-mentioned technical advantages advantageously results.

A method for producing a key is also proposed, a key body of the key comprising a first balance rail pin recess for receiving the first balance rail pin and comprising at least one further balance rail pin recess for receiving a further balance rail pin being provided in an additive manufacturing method. Alternatively or additionally, the key body can be produced to comprise at least one fastening element for fastening a replaceable guide insertion element in a recess in the key body. In this case, the key body can also be produced to comprise at least one front pin recess for receiving a front pin.

An additive manufacturing method can in particular be a 3D printing method. In an embodiment of this kind, the key body can in particular be made of plastics material, metal, or another printable material. The material of a key produced in the additive manufacturing method can be a plastics material, in particular a fiber-reinforced plastics material, such as a carbon-fiber, fiberglass, or basalt-fiber-reinforced material. The method advantageously allows a key to be produced in a simple manner in accordance with one of the embodiments described in this disclosure having the advantages that have likewise already been described.

It is, however, not absolutely necessary to use an additive manufacturing method to produce the key. A method for producing a key, with a key body being provided, for example made of wood or another material, is also proposed. A first balance rail pin recess for receiving the first balance rail pin and at least one further balance rail pin recess for receiving a further balance rail pin is also made in the thus provided key body. This can be carried out by suitable methods, such as machining methods, e.g. milling methods or drilling methods, for example.

Alternatively or additionally, at least one fastening element for fastening a replaceable guide insertion element in the front pin recess is made in the key body. This can also be carried out by means of the above-mentioned machining methods. It is also possible for at least one front pin recess for receiving a front pin to be made in the key body. This method also advantageously allows a key to be produced in a simple manner in accordance with one of the embodiments described in this disclosure.

A method for producing a piano key, with a key body of the piano key being produced in an additive manufacturing method, is also described. The material of a key produced in the additive manufacturing method can be a plastics material, in particular a fiber-reinforced plastics material, such as a carbon-fiber, fiberglass, or basalt-fiber-reinforced material. This can advantageously provide the desired stability of the key. In this case, the key body can in particular be produced to comprise a balance rail pin recess for receiving a balance rail pin and/or to comprise at least one front pin recess for receiving a front pin. The method can also be developed in accordance with one of the above-mentioned aspects. In this embodiment, however, it is not absolutely necessary for the key body to be produced to comprise at least one further balance rail pin recess and/or to comprise at least one fastening element for fastening a replaceable guide insertion element.

A key comprising a weight portion, with this being able to be arranged or formed on a lower face of the key, in particular in the form of a raised portion, is also described. It can have a convex shape. It is also conceivable for the weight portion, which can be a contact portion for resting on a balance rail, to project beyond the surface formed by the remaining lower face, i.e. to protrude downward from the key body. The key can also be developed in accordance with one of the above-mentioned aspects.

A guide insertion element in accordance with one of the embodiments described in this disclosure and a method for producing an insertion element of this kind are also described.

A balance rail pin in accordance with one of the embodiments described in this disclosure and a method for producing a balance rail pin of this kind are also described.

### BRIEF DESCRIPTION OF THE DRAWING FIGURES

The invention is explained in greater detail on the basis of exemplary embodiments. In the drawings:

FIG. 1 is a schematic longitudinal section through a key according to the invention,

FIG. 2 is a schematic plan view of the key shown in FIGS. 1,

FIG. 3 is a schematic view of the key shown in FIG. 1 from below,

FIG. 4A is a side view of a first balance rail pin,

FIG. 4B is another embodiment of a side view of a first balance rail pin,

FIG. 4C is a side view of a further balance rail pin,

FIG. 5A is a side view of a felt insertion element,

FIG. 5B is a plan view of a felt insertion element,

FIG. 6A is a schematic longitudinal section through a front pin portion of a key,

FIG. 6B is a schematic view of the front pin portion shown in FIG. 6A from below,

FIG. 6C is a schematic view of the front pin portion shown in FIG. 6A from below, with inserted felt insertion elements,

FIG. 7A is a schematic longitudinal section through an arrangement according to the invention in an initial state, and

FIG. 7B is a schematic longitudinal section through an arrangement according to the invention in a removal state.

In the following, identical reference signs denote elements having identical or similar technical features.

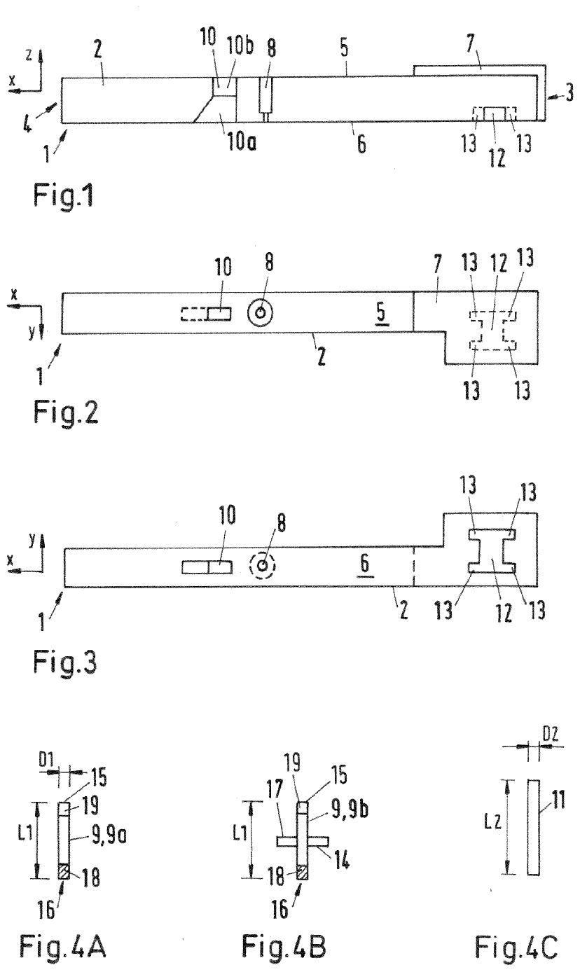

FIG. 1 is a schematic longitudinal section through a key 1 according to the invention. The key 1 comprises a key body 2 having a front end 3 and a rear end 4. A longitudinal axis x is shown, with a longitudinal direction of extension being oriented from the front end 3 to the rear end 4 of the key 1. The key body 2 comprises an upper face 5 and a lower face 6. A vertical axis z is also shown, which is oriented from the lower face 6 to the upper face 5. A covering 7 is arranged on the front end 3 of the key body 2, both on the upper face 5 and on the front end face, a player contacting the key 1 in the region of this covering 7 when it is used as intended. The upper face and the lower face 5, 6 are each designed to be non-curved. However, this is not necessary. The upper face and/or lower face 5, 6 can also be designed to be curved. The key body 2 comprises a first balance rail pin recess 8 for receiving a first balance rail pin 9 (see FIG. 4A). Likewise, the key body 2 comprises a further balance rail pin recess 10 for receiving a further balance rail pin 11 (see FIG. 4C). Both recesses 8, 10 are each arranged on the lower face 6 and are designed as through-openings which extend from the lower face 6 to the upper face 5 of the key body 2. It is, however, also possible for the first balance rail pin recess 8 to be open toward the lower face 6 and to be designed in the manner of a blind hole.

It is shown that the first balance rail pin recess 8 comprises two cylindrical segments, which have different diameters. The diameters increase from the lower face 6 to the upper face 5 of the key body 2. In this case, the cylindrical segment having the lower diameter forms a so-called key base of the first balance rail pin recess 8. The configuration having two cylindrical segments is merely exemplary, however. The entire first balance rail pin recess 8 can also be designed to be cylindrical and to have a constant diameter, in particular if it is designed in the manner of a blind hole.

The first balance rail pin recess 8, in particular the segment having the lower diameter, is used to receive the first balance rail pin 9 or a portion of this pin 9 in a form-fitting manner. As a result, translational movability of the key body 2 along the longitudinal axis x can be lessened or reduced. The further balance rail pin recess 10 tapers from the lower face 6 toward the upper face 5. For instance, the further recess 10 in particular comprises a truncated-pyramid-shaped portion 10a and a square portion 10b. The truncated-pyramid-shaped portion 10a tapers from the lower face 6 toward the upper face 5, but only extends over part of the distance from the lower face to the upper face 4, with the square portion 10b connecting an upper end of the truncated-pyramid-shaped portion to the upper face 5. In this case, the further recess 10 is designed to be rectangular in a cross-sectional plane oriented perpendicularly to the vertical axis z. It serves to receive the further balance rail pin 11 or a portion thereof. As a result, rotational movability, in particular the key 1 tilting about a rotational axis parallel to the longitudinal axis of extension x, can be reduced.

Both recesses 8, 10 are arranged in a central portion of the key body 2. In this case, the first recess 8 is arranged in front of the further recess 10 in the longitudinal direction of extension. A distance between the first and the further recess 8, 10 can in particular be less than 2 cm in the longitudinal axis of extension. This distance can for example be between the geometric midpoints of the openings formed on the lower face by the recesses 8, 10. These geometric midpoints can be arranged on a straight line oriented in parallel with the longitudinal axis x.

FIG. 1 does not show a guide element which is e.g. designed as a felt element and can be arranged in at least one portion of the first and/or the further recess 8, 10. Of course, the key body 2 and a guide element of this kind can also be designed to be monolithic. The guide element can also be part of a replaceable guide insertion element.

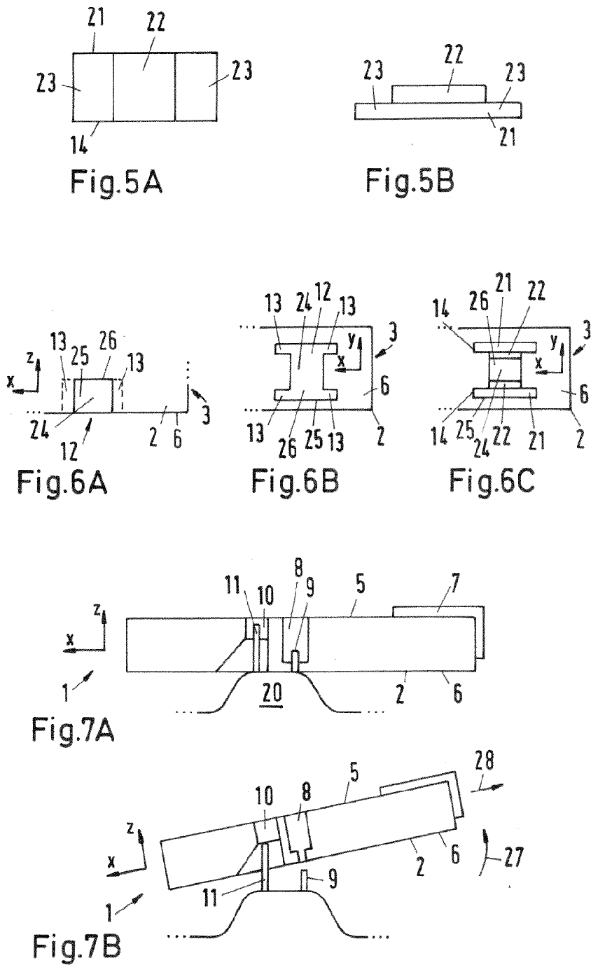

A front pin recess 12, which is arranged on the lower face 6 at the front end of the key body 2, is also shown. This recess 12 is a blind hole-like recess and is used to receive a replaceable guide insertion element 14 (see FIG. 5A). It is shown that the front pin recess 12 comprises undercut portions 13, which are explained in greater detail in the following. They make it possible to detachably fasten a guide insertion element 14 in the front pin recess 12, and this makes it possible to replace this guide insertion element 14. It is shown that the undercut portions 13 extend over the entire depth of the front pin recess 12. However, this is not necessary. It is also possible for the undercut portions 13 to extend only over part of the depth of the front pin recess 12.

FIG. 2 is a schematic plan view of the key 1 shown in FIG. 1 and FIG. 3 is a schematic view of said key from below. These figures show the first and the further balance rail pin recess 8, 10 as well as the front pin recess 12 comprising the undercut portions 13.

FIG. 4A is a schematic side view of a first balance rail pin 9a. It is designed to be cylindrical and has a length L1 and a diameter D1. The pin 9a is designed to be received in the first balance rail pin recess 8 in a form-fitting manner, in particular in the portion of the recess 8 that forms the key base. In order to fasten the balance rail pin 9a to a main body of the keyboard instrument, a balance-rail-side end 16 of the first balance rail pin 9a can be driven into said main body, in particular into a frame portion of the main body.

FIG. 4B is another embodiment of a schematic side view of a first balance rail pin 9b. It likewise comprises a cylindrical portion having a length L1 and a diameter D1. In addition to the embodiment shown in FIG. 4A, the balance rail pin 9b comprises or forms a support element 14 in a central region along the longitudinal extension. It can e.g. be (hollow) disk-shaped, with the cylindrical portion extending through the inner opening in the hollow-disk-shaped support element 14. An upper face, i.e. a face oriented toward the free end 15 of the balance rail pin 9b, forms a support surface 17 for a lower face 6 of the key body 2 (see FIG. 1). As explained, the free end 15 comprises an actuation portion 19 and the balance-rail-side end 16 comprises a threaded portion 18. This threaded portion 18 serves to screw the balance rail pin 9b into the main body or a frame portion of the main body. A balance rail 20 can be arranged on the frame portion (see FIG. 7a). This is not absolutely necessary, however, since the function of this balance rail 20 is performed by the support element 14. The balance rail pin comprises or forms an actuation portion 19 at a free end 15, which is the end opposite the balance-rail-side end 16 along the longitudinal extension. This serves to provide tool-assisted actuation, for example for actuation by means of a screwdriver or a socket key. For instance, the actuation portion 19 can e.g. serve as a portion for receiving a screwdriver blade or a socket portion of a socket key. It is thus possible to actuate, for example rotate, the balance rail pin 9a from above through the first balance rail pin recess 8 using a tool, in order to e.g. screw it into the balance rail 20 or out of the main body or the frame portion.

By screwing the balance rail pin 9b in/out, as explained in relation to FIG. 4A, the height of the support surface 17 above the surface of the main body or the frame portion and thus also an installation height of the key 1 can be set, which is desired in particular when leveling the keys 1. Alternatively or additionally, it is possible for spacer elements, such as felt elements, to be fastened to the support surface 17, and they can likewise be used to set the height of the support surface 17 above the surface of the balance rail 20.

FIG. 4C is a schematic side view of a further balance rail pin 11. It is designed to be cylindrical and has a length L2 and a diameter D2. The pin 11 is designed to be received in the further balance rail pin recess 10 in a form-fitting manner. The length L2 of the further balance rail pin 11 is greater than the length L1 of the first balance rail pin 9, 9a, 9b. The diameter D2 of the further balance rail pin 11 can be greater than, less than, or equal to the diameter D1 of the first balance rail pin 9, 9a, 9b.

FIG. 5A is a schematic side view of a guide insertion element designed as a felt insertion element 14 and FIG. 5B is a schematic plan view of the guide insertion element 14 shown in FIG. 5A. Of course, the guide insertion element can also be in a form other than a felt insertion element 14. It comprises a carrier plate 21, which can e.g. be made of plastics material. The carrier plate 21 can be produced in an additive manufacturing method, e.g. in a 3D printing method. The guide insertion element 14 also comprises a guide element designed as a felt element 22. This is fastened, e.g. bonded, to the carrier plate 21 in a central region of a side surface of said carrier plate. If the felt element 22 is fastened to a portion of the side surface, the guide insertion element 14 still has side portions 23 that are free, i.e. not covered by the felt element 22. These are designed to be received in undercut portions 13 of a front pin recess 12 (see FIG. 1) in a form-fitting manner.

FIG. 6A is a schematic longitudinal section through a key body 2 (see FIG. 1) in the region of a front pin recess 12. It shows a receiving volume 24 for receiving a front pin (not shown) and undercut portions 13 (shown by dashed lines). It likewise shows a lateral side surface 25 of the recess 12, i.e. a side surface which delimits the receiving volume 24 along a transverse axis y (see FIG. 6B). It shows that the lateral side surface 25 of the receiving volume 24 is completely delimited. However, this is not necessary, since it is also possible to only delimit it in portions. The recess 12 is arranged on the lower face 6 in the front end region of a key body 2 and is open at the bottom. The recess 12 is designed in the manner of a blind hole and is delimited at the top by a cover surface 26 formed by the key body 2. This cover surface 26 forms a stop surface for a guide insertion element 14, which can be slid into the recess 12 from below.

FIG. 6B is a schematic view of the key body 2 shown in FIG. 6A from below in the region of a front pin recess 12. It shows the receiving volume 24 as well as the undercut portions 13 and the cover surface 26. The guide insertion element 14 shown in FIG. 5A can be slid into this recess 12, the free side portions 23 of the guide insertion element 14 being slid along the side surface 25 into the undercut portions 23 until the guide insertion element 14 hits the cover surface 26. In this case, a height of the guide insertion element 14 is equal to or a predetermined amount less than a height of the recess 12 along a vertical axis z (see FIG. 6A). In the inserted or slid-in state, the felt element 22 of the guide insertion element 14 then delimits the receiving volume 24 along the transverse axis y and can thus provide movement guidance for a front pin.

FIG. 6C is a schematic view of the key body 2 shown in FIG. 6A from below in the region of a front pin recess 12 comprising two inserted guide insertion elements 14. Both guide insertion elements 14 are each inserted into the undercut portions 23 arranged on the opposite transverse sides of the recess 12 by their free side portions 23. The felt elements 22 thus delimit the receiving volume 24 in and counter to the transverse axis y. The guide insertion elements 14 are simple to insert and also remove from the recess 12 again, which makes it possible to replace and thus maintain them in a simple manner, e.g. when a felt element 22 is worn and accurate movement guidance of the key 1 is no longer possible. Therefore, a length of the guide insertion element 14 corresponds to a length of the recess 12 in the region of the undercut portions 13 and a length of the felt element 22 corresponds to a length of the recess 12 in the region outside the undercut portions 13, the length being measured along the longitudinal axis of extension x of the key body 2. A thickness of the carrier plate 21 of the guide insertion element 14 corresponds to the thickness of an undercut portion 13 or is greater than this thickness by a predetermined amount, the thickness being measured along the transverse axis y of the key body 2 in order for it to be possible to clamp the guide insertion element into the undercut portion 13. However, it is of course also possible to select a lower thickness of the guide insertion element, with a different type of fastening then having to be provided.

The recess 12 shown in FIGS. 6A, 6B, and 6C for receiving guide insertion elements 14 is a front pin recess 12, purely by way of example. However, the key body 2 can also comprise or form at least one fastening element for replaceably fastening at least one guide insertion element 14 in at least one of the two balance rail pin recesses.

FIG. 7A and FIG. 7B are schematic side views of a key 1 when removing the key, e.g. for maintenance purposes, or in a state for inserting washers for setting the key height, e.g. when leveling them. FIG. 7A shows an initial state in this case. In this figure, a central portion of a lower face 6 of the key body 2 of the key 1 rests on a balance rail 20. A first balance rail pin 9 is arranged in a first balance rail pin recess 8 in the key body 2 and a further balance rail pin 11, which is longer than the first balance rail pin 9, is arranged in a further balance rail pin recess 10. In order to remove the key 1, it is merely tilted about a rotational axis oriented in parallel with a transverse axis y (see e.g. FIG. 3), e.g. by actuating the lower face 6 at the front end 3 of the key 1. During the tilting, which is shown by an arrow 27, the first balance rail pin 9 is moved out of the first balance rail pin recess 8. As a result, longitudinal displacement of the key body 2, i.e. a movement in or counter to the longitudinal axis of extension x of the key body 2, is enabled. The key 1 can then be removed in a removal direction, symbolized by an arrow 28. In this process, the further balance rail pin 11 slides along a cover surface of the further balance rail pin recess 10.

What is claimed is:

1. An arrangement comprising a first balance rail pin and at least one key, a key body of the key comprising a first balance rail pin recess for receiving the first balance rail pin, the key body comprising at least one further balance rail pin recess for receiving a further balance rail pin, the first balance rail pin being arranged in the first balance rail pin recess, the arrangement comprising at least one further balance rail pin, which is arranged in the further balance rail pin recess,
wherein
the first balance rail pin comprises a support portion for supporting the key, a lower face of the key body resting on an upper surface of the support portion, the first balance rail pin comprising a threaded portion for screwing into a thread or material of the balance rail.

2. The arrangement according to claim 1, wherein the further balance rail pin is longer than the first balance rail pin.

3. The arrangement according to claim 1 wherein the first balance rail pin comprises an actuation portion for tool-assisted actuation.

4. The arrangement according to claim 1 wherein the further balance rail pin recess comprises at least one portion that tapers from a lower face of the key body toward the upper face.

5. The arrangement according to claim 1 wherein a distance between the first and the further balance rail pin recess is less than 2 cm.

6. The arrangement according to claim 1 wherein a guide element is arranged in at least one portion of the first and/or the further balance rail pin recess and/or in a portion of a front pin recess in the key body.

7. The arrangement according to claim 1 wherein the further balance rail pin recess is rectangular in a cross-sectional plane.

8. The arrangement according to claim 1 wherein the key body comprises at least one fastening element for fastening at least one replaceable guide insertion element in at least one recess in the key body.

9. The arrangement according to claim 8, wherein the at least one fastening element is designed as an undercut portion in the recess.

10. The arrangement according to claim 9, wherein the undercut portion does not extend over the entire depth of the recess.

11. The arrangement according to claim 8, wherein the arrangement comprises the at least one replaceable guide insertion element, the at least one guide insertion element being arranged in at least one recess in the key body.

12. The arrangement according to claim 11, wherein the guide insertion element comprises a guide element and a carrier element.

13. A method for producing an arrangement comprising a first balance rail pin, at least one further balance rail pin and at least one key,
a key body of the key comprising a first balance rail pin recess for receiving the first balance rail pin and comprising at least one further balance rail pin recess for receiving a further balance rail pin being provided,
the first balance rail pin being arranged in the first balance rail pin recess,
the further balance rail pin being arranged in the further balance rail pin recess,
characterized in that
the first balance rail pin comprises a support portion for supporting the key body, a lower face of the key body being arranged to rest on an upper surface of the support portion, the first balance rail pin comprising a threaded portion for screwing into a thread or material of the balance rail.

14. A key of a keyboard instrument, in particular for an arrangement according to claim 1, the key body of the key comprising a first balance rail pin recess for receiving a first balance rail pin, translational movability of the key body relative to the first balance rail pin and in parallel with a longitudinal axis of extension of the key body being reduced when the first balance rail pin is arranged in the first balance rail pin recess,
wherein the key body comprises at least one further balance rail pin recess for receiving a further balance rail pin, the further balance rail pin recess comprising at least one portion that tapers from a lower face of the key body toward the upper face and rotational movability of the key body about an axis oriented in parallel with the longitudinal axis of extension of the key body being reduced when the further balance rail pin is arranged in the further balance rail pin recess, and/or the key body comprising at least one fastening element for fastening at least one replaceable guide insertion element in at least one recess in the key body.

15. The method of claim 13 for producing a key, wherein
in an additive manufacturing method, a key body of the key comprising a first balance rail pin recess for receiving a first balance rail pin and at least one further balance rail pin recess for receiving a further balance rail pin and/or comprising at least one fastening element for fastening a replaceable guide insertion element in at least one recess in the key body is produced, or
a key body is provided, wherein a first balance rail pin recess for receiving a first balance rail pin and at least one further balance rail pin recess for receiving a further balance rail pin and/or at least one fastening element for fastening at least one replaceable guide insertion element in at least one recess in the key body is made in the key body.

16. The arrangement according to claim 2, wherein the first balance rail pin comprises an actuation portion for tool-assisted actuation.

17. The arrangement according to claim 9, wherein the arrangement comprises the at least one replaceable guide insertion element, the at least one guide insertion element being arranged in at least one recess in the key body.

18. The arrangement according to claim 10, wherein the arrangement comprises the at least one replaceable guide insertion element, the at least one guide insertion element being arranged in at least one recess in the key body.

19. The arrangement according to claim 3, wherein the further balance rail pin recess is rectangular in a cross-sectional plane.

20. The arrangement according to claim 4, wherein the further balance rail pin recess is rectangular in a cross-sectional plane.
